(19) United States
(12) Patent Application Publication
(10) Pub. No.: US 2017/0055764 A1
(43) Pub. Date: Mar. 2, 2017

(54) APPARATUS AND METHOD FOR STEAMING MILK

(71) Applicants: Douglas Joseph Weber, San Francisco, CA (US); Craig Robert Lyn, Los Angeles, CA (US)

(72) Inventors: Douglas Joseph Weber, San Francisco, CA (US); Craig Robert Lyn, Los Angeles, CA (US)

(73) Assignee: Strategic Exits LLC, Los Angeles, CA (US)

(21) Appl. No.: 15/180,409

(22) Filed: Jun. 13, 2016

Related U.S. Application Data
(60) Provisional application No. 62/209,159, filed on Aug. 24, 2015.

(51) Int. Cl. A47J 31/44

(52) U.S. Cl. CPC A47J 31/4489

(57) ABSTRACT

A device for steaming and/or foaming milk primarily for, but not limited to, coffee beverages. The device attaches via machined threads to a standard coffee machine steam wand, but nonstandard sizes can be accommodated via a thread adapter. The device consists of two machined stainless pieces each with crescent shaped apertures that, when rotated relative to each other, allow for the increase or decrease in effective hole size to adjust the volume and pressure of steam being expunged. This adjustability allows for the user to decrease the aperture when foaming a small amount of milk (e.g. for a macchiato), or to increase the aperture for foaming more milk (e.g. for a latte).

### FIELD OF THE INVENTION

The present disclosure relates generally to steam nozzle tips for steaming milk for café beverages.

### BACKGROUND

The steaming of milk for café beverages is well known. Typically, milk or a café beverage is treated with a nozzle wand connected to a steam source. Commercial and home espresso machines, for example, often include a steam generation unit including a standard steam wand connected to a boiler. The steam can serve to heat the milk, foam the entire body of milk, and/or generate a froth over the milk, prior to or after addition of other beverage ingredients. As café beverage consumers continue to become more sophisticated in their tastes, a number of different aspects of beverage have evolved, but little attention has been paid to improving the quality of milk steaming. Different steam nozzle tips and froth assistors are available, but often such options are inadequate for achieving the desired degree of steaming, foaming or frothing.

Accordingly, a need exists for an improved steam nozzle for milk or café beverage steaming.

### SUMMARY

In one aspect, an adjustable steam nozzle tip is disclosed. The adjustable steam nozzle tip can include a body having a first end and a second end. The first end can include one or more internal apertures and the second end can include an opening configured to attach to a nozzle wand. The adjustable steam nozzle tip can include a cap movably connected to the body. The cap can include one or more external apertures.

In another aspect, a method of providing steam for a beverage including milk is disclosed. The method can include providing a steam nozzle tip including a nozzle tip cap attached to a nozzle tip body. The method can include moving the nozzle tip cap relative to the nozzle tip body to adjust a hole for the steam nozzle tip.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

Embodiments will now be described with reference to the following drawings, which are provided by way of example, and not limitation.

FIG. 1 is a front and left picture view of a nozzle wand with a non-adjustable steam nozzle tip.

FIG. 2 is a front and right isometric view of an adjustable steam nozzle tip apparatus in accordance with an embodiment, with some components shown transparent or omitted for purposes of illustration.

FIG. 3 is an exploded front and right isometric view of the embodiment of FIG. 2, showing a rotatable tip cap, body, and retaining gasket.

FIG. 4 is an exploded back and left isometric view of the embodiment of FIG. 2, showing a rotatable tip cap and body, with some components omitted for purposes of illustration.

FIG. 5 is a front and right isometric view of the embodiment of FIG. 2 connected to a nozzle wand.

FIG. 6 shows two isometric views of a rotatable tip cap and body having labels, in accordance with an embodiment.

FIG. 7 is a schematic cross section of different combinations of apertures in a rotatable tip cap and corresponding body that can cooperate to provide steam adjustability in accordance with nine different embodiments.

### DETAILED DESCRIPTION

Embodiments of the present disclosure provide steam nozzle tips that can be readily adjusted by a user for different conditions (e.g., quantity of milk, pressure generated by the boiler, user tastes and desired degree of foaming or frothing, etc.). In particular, the present disclosure relates to adjusting a relative degree of alignment between holes on different relatively movable parts of a steam nozzle tip to achieve an adjustable nozzle output stream size and/or shape for creating a good quality foam under a variety of conditions.

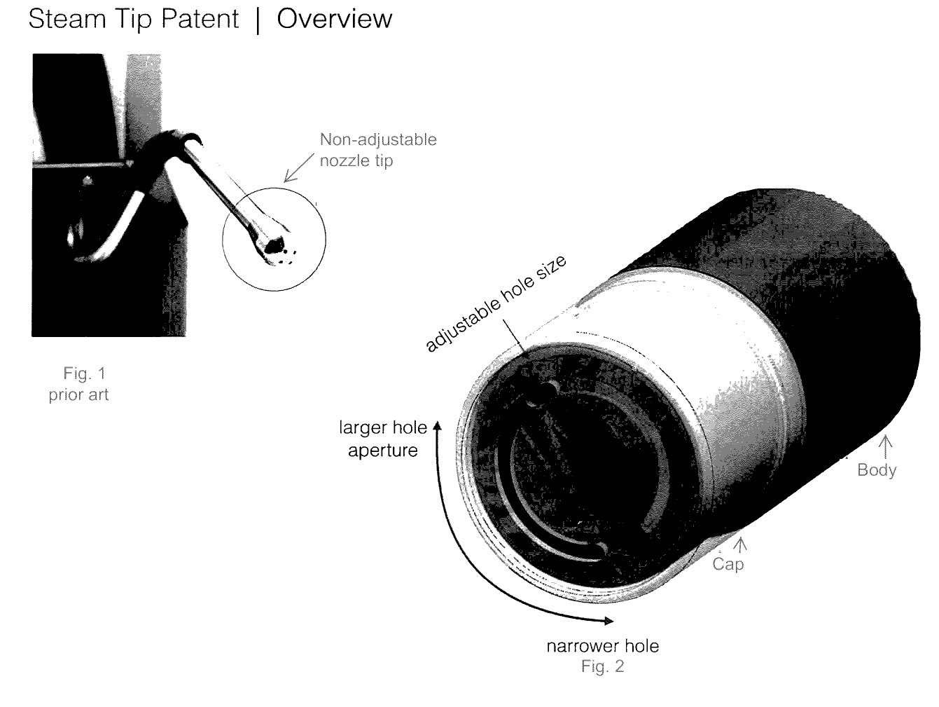

FIG. 1 illustrates a conventional steam nozzle tip with four fixed holes typical of the prior art in this technical field. Variable conditions, such as the steam pressure of the machine being used and the quantity of milk being foamed, can cause the quality of foam from non-adjustable steam nozzle tips such as those illustrated in FIG. 1 to be inconsistent. Accordingly, apparatuses and methods are described herein for improved steam nozzle tips having a movable cap that can allow tailoring of the steam nozzle output.

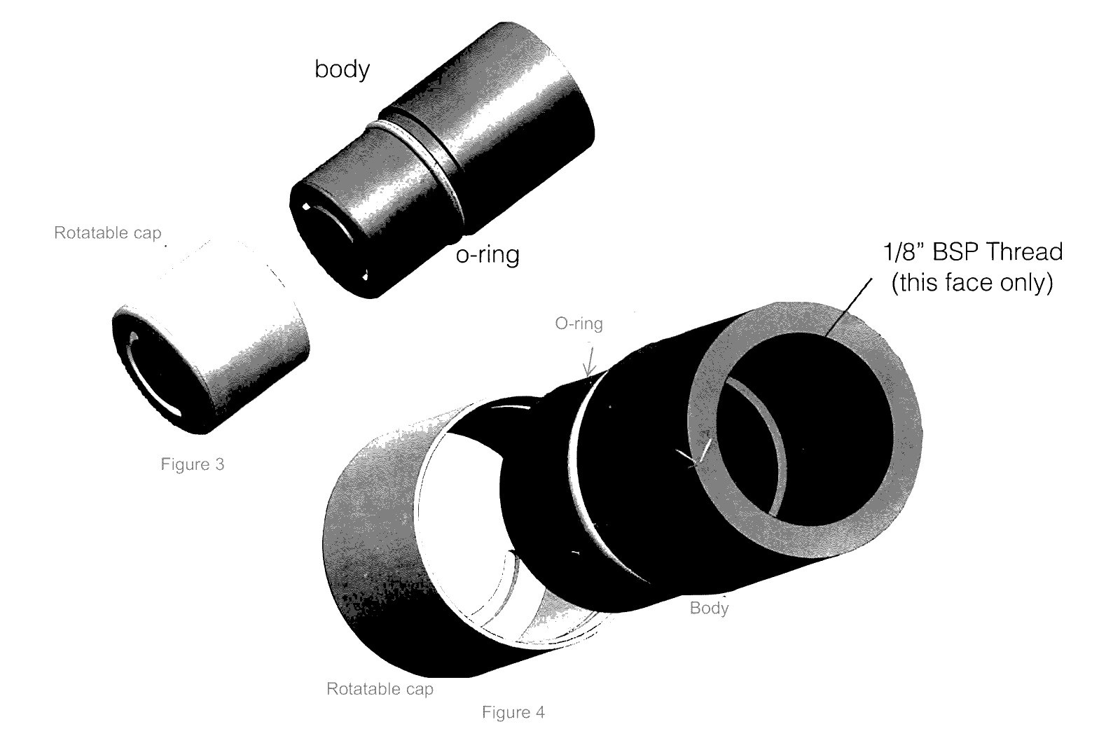

FIG. 2 illustrates an embodiment of an adjustable steam nozzle tip. As shown in FIG. 2, the adjustable steam nozzle tip may include a cap and a body that are attached to one another in a manner than allows relative movement. For example, the cap may be connected to the body such that the cap may rotate and/or translate relative to the body. The cap includes one or more external apertures (also referred to as outer holes) while the body includes one or more internal apertures (also referred to as inner holes). In an embodiment, relative movement of the cap may adjust a relative degree of alignment between the one or more external apertures of the cap and the one or more internal apertures of the body. The overlap, or aligned portions of the internal and external apertures, can be referred to as the “adjustable aperture(s)” or “adjustable hole(s).” For example, from the starting position shown in FIG. 2, the size of the adjustable hole may increase if the cap is rotated in a clockwise direction and may decrease if the cap is rotated in a counterclockwise direction. The relative degree of alignment may affect the speed and/or shape of the stream of steam ejected from the adjustable steam nozzle tip during operation. As a result, the adjustable hole may be adjusted to create an optimal size for generating good quality foam under a variety of conditions, such as different user tastes, steam pressures, and/or milk quantities.

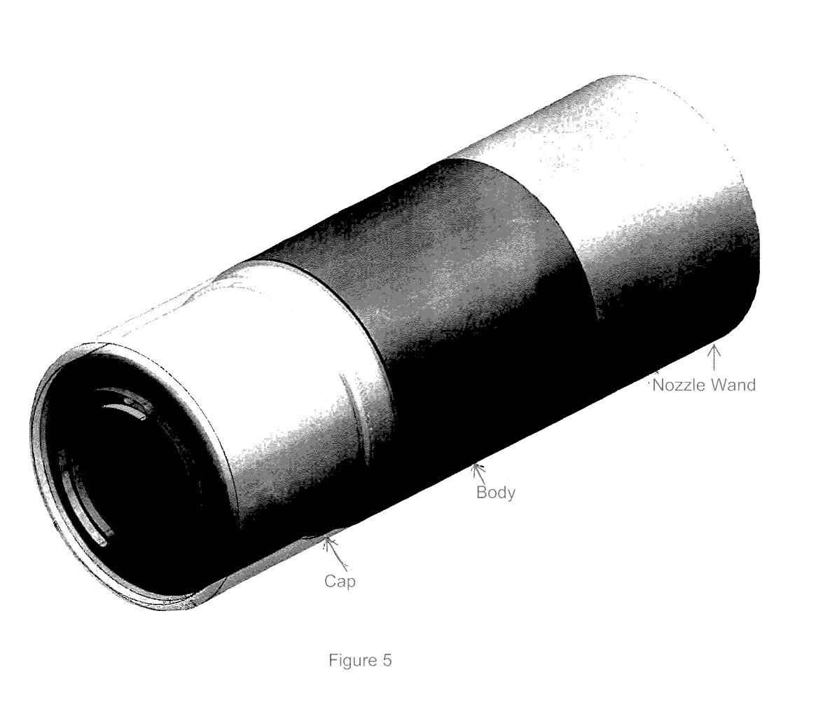

FIGS. 3 and 4 illustrate exploded views of the adjustable steam nozzle tip embodiment shown in FIG. 2. FIGS. 3 and 4 each illustrate a rotatable cap, a body, and a retaining gasket (referred to in the drawings as an o-ring) of the adjustable steam nozzle tip. In an embodiment, the rotatable cap is configured to fit over one end of the body and snap into position over the retaining gasket. The illustrated mechanism attaches the cap to the body in a manner that allows relative movement, particularly relative rotation. Other types of connections between the cap and body that allow the desired relative movement can also be employed. In an embodiment, the connection between the cap and body is configured to allow relative movement by hand operation (without tools), and yet resist movement during operation such that the cap does not auto rotate when steam is ejected from the nozzle tip. As further shown in FIG. 4, one end of the body is configured to removably attach to a standard nozzle wand, such as that shown in FIG. 1. In particular, the distal end of the body can be internally threaded with a ⅛ inch British Standard Pipe (BSP) thread to facilitate attachment to a standard nozzle wand via a threaded attachment.

FIG. 5 illustrates the adjustable steam nozzle tip embodiment shown in FIG. 2 connected to a nozzle wand. As shown in FIG. 5, the adjustable steam nozzle tip may have a circular cross section. Other cross sectional shapes will also be appreciated by the skilled artisan, such as, for example, square.

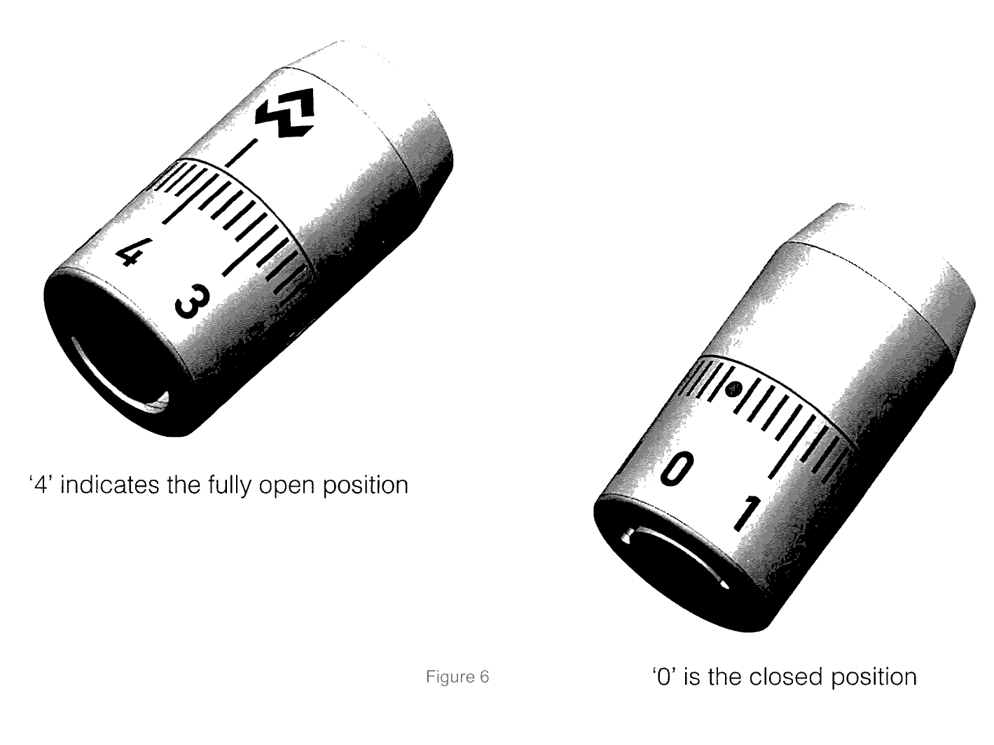

FIG. 6 illustrates two views of an adjustable steam nozzle tip, similar to that shown in FIG. 2, with flow markings ranging from fully open to fully closed in accordance with an embodiment. For example, as shown in FIG. 6, the markings may be positioned relative to the internal and external apertures of the body and cap, respectively, such that aligning a “4” on the rotatable cap with a marking on the body may indicate the fully open position, while aligning a “0” on the rotatable cap with the same marking on the body may indicate the fully closed position. Thus, the flow markings may correspond to the relative degree of alignment between external aperture(s) of the cap and internal aperture(s) of the body, and thus represent relative size of the adjustable hole for the steam nozzle tip formed by such alignment.

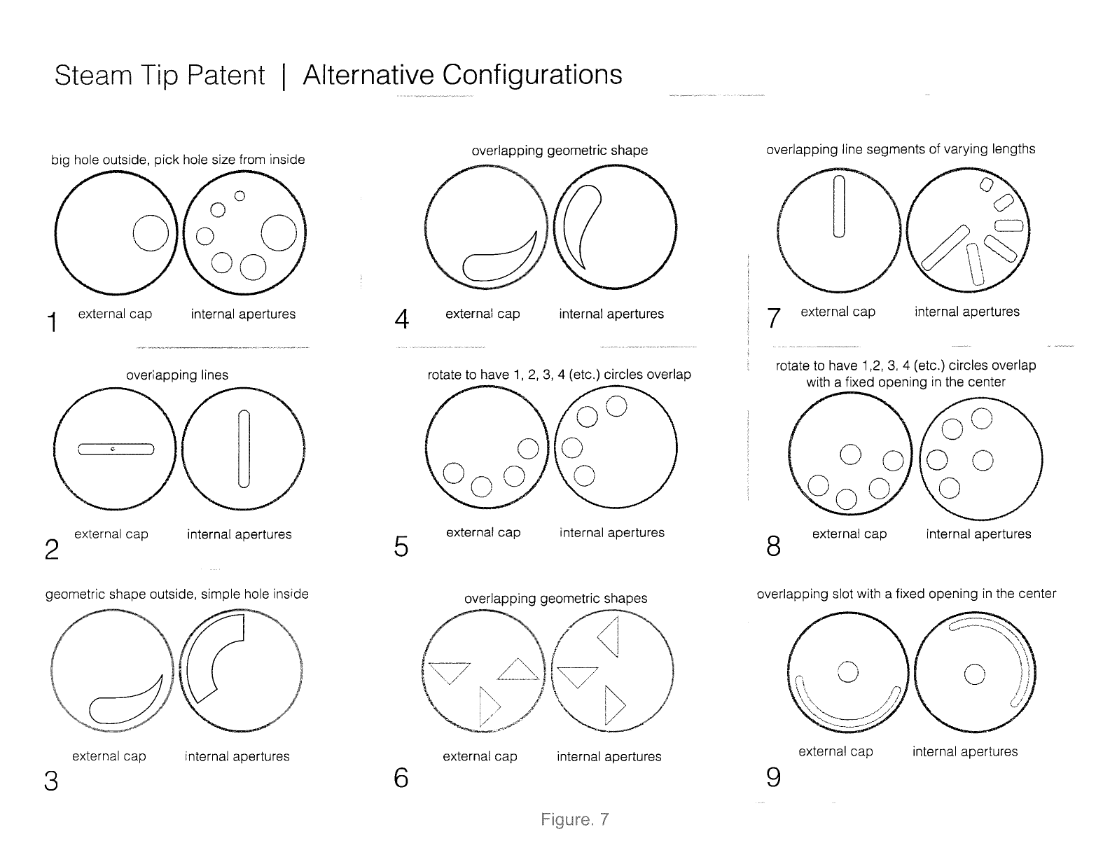

FIG. 7 illustrates nine different examples of cap and body pairs with different internal and external aperture shapes, numbers and sizes. Other embodiments are also envisioned, as will be appreciated by the skilled artisan. As shown in FIG. 7, the one or more internal apertures and the one or more external apertures may include apertures that are axially symmetric, axially asymmetric, and/or a combination thereof. For example, examples (1) and (3)-(9) include axially asymmetric apertures; example (2) includes only axially symmetric apertures; and examples (8) and (9) include both axially symmetric and axially asymmetric apertures.

In all of the illustrated examples, the relative degree of alignment between the apertures on the external cap and the apertures on the body may determine the speed and/or shape of a stream of ejected steam from a boiler attached to the steam wand. For example, in example (1) a single external aperture on the rotatable cap can align with any of a number of differently sized internal apertures of the body; in this example the internal aperture selected to align with the larger external aperture effectively defines the hole through which steam is ejected for the adjustable steam nozzle tip formed by the combination of the cap and the body. The skilled artisan will appreciate that the single larger aperture may be provided instead as an internal aperture on the body, while the multiple different sized openings may be provided as external apertures on the cap, which may have the advantage of providing visibility and obviating the separate markings of FIG. 6.

In example (2), the two slots may align such that the adjustable hole for the nozzle tip takes the form of a relatively large slot, whereas other rotational positions of the cap would produce a smaller rhombus shape.

In example (3), the differently shaped internal and external apertures allow tailoring both the size and the shape of the adjustable hole for the nozzle tip. Similarly for example (4), although the internal and external apertures may have the same shape, their overlap can define different shapes depending upon which ends of the apertures are overlapping.

In example (5), similarly sized and shaped internal and external apertures can produce an overall adjustable hole that comprises different numbers of overlapping apertures.

Example (6) is similar to example (5) but adds the dimension of different degrees of alignment or overlap among the apertures allowing different sizes of the overall adjustable hole.

Example (7) is similar to example 1 in that one larger external aperture (in the form of a slot) can be aligned with any of multiple differently sized internal apertures (also in the form of a slot), or vice versa.

Example (8) is similar to Example (5) except that each of the cap and the body have a central aperture that remain aligned in any rotational position of the cap, thus setting a minimum size for the adjustable hole. Example (9) is a similar variation adding always-aligned central apertures to the arcuate slot example of FIGS. 2-6.

While the illustrated embodiments of the adjustable steam nozzle tip employ rotatable caps that are rotatably attached to a body, the skilled artisan will appreciate that a cap attached in a manner that allows other types of movement (e.g., linear translation) relative to the body can similarly achieve adjustability in the steam nozzle output, where the cap includes one or more external apertures and the body includes one or more internal apertures.

Thus, the user (e.g., a consumer at home or a barista) may adjust the relative degree of alignment between the apertures of the cap and body so as to tailor steaming of milk or café beverages for given conditions or tastes.

Various other modifications, adaptations, and alternative designs are of course possible in light of the above teachings. Therefore, it should be understood at this time that within the scope of any appended embodiments the invention may be practiced otherwise than as specifically described herein. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended embodiments. Any methods disclosed herein need not be performed in the order recited. The methods disclosed herein include certain actions taken by a user; however, they can also include any third-party instruction of those actions, either expressly or by implication.

1. An adjustable steam nozzle tip, comprising:
a body having a first end and a second end, the first end comprising one or more internal apertures and the second end comprising an opening configured to attach to a steam nozzle wand; and
a cap movably connected to the body, the cap comprising one or more external apertures.

2. The adjustable steam nozzle tip of claim 1, wherein the cap is rotatably connected to the body.

3. The adjustable steam nozzle tip of claim 2, configured such that rotation of the cap relative to the body adjusts a relative degree of alignment between the one or more external apertures of the cap and the one or more internal apertures of the body, wherein the relative degree of alignment affects the speed and/or shape of steam ejected in operation.

4. The adjustable steam nozzle tip of claim 2, wherein each of the one or more internal apertures and the one or more external apertures comprises at least one axially asymmetric aperture.

5. The adjustable steam nozzle tip of claim 4, wherein each of the one or more internal apertures and the one or more external apertures further comprises an axially symmetric aperture.

6. The adjustable steam nozzle tip of claim 2, further comprising a retaining gasket coupled to the body, wherein the gasket is situated between the first and second end.

7. The adjustable steam nozzle tip of claim 1, wherein the body comprises an internally threaded end for connection to the steam nozzle wand.

8. An adjustable steam nozzle comprising the adjustable steam nozzle tip of claim 1 and a steam nozzle wand.

9. A method of providing steam for a beverage comprising milk, the method comprising:
providing a steam nozzle tip comprising a nozzle tip cap attached to a nozzle tip body; and
moving the nozzle tip cap relative to the nozzle tip body to adjust a hole for the steam nozzle tip.

10. The method of claim 9, wherein moving comprises rotating.

11. The method of claim 9, wherein moving comprises sliding.

12. The method of claim 10, wherein moving comprises changing a degree of alignment between one or more internal apertures of the nozzle tip body and one or more external apertures of the nozzle tip cap.

13. The method of claim 9, further comprising providing steam from a boiler through a nozzle wand and the nozzle tip.

14. An adjustable steam nozzle wherein the adjustable cap of claim 2 attaches directly to the steam nozzle wand, and the steam nozzle wand is configured to have the apertures of the body in claim 1.
